(19) United States
(12) Patent Application Publication
(10) Pub. No.: US 2016/0240928 A1
(43) Pub. Date: Aug. 18, 2016

(54) PROTECTION FOR WIRELESS LINKS AT TRAIN CARRIAGE ROOFTOPS AGAINST JAMMING AND INTERFERENCE

(71) Applicant: Alstom Transport Technologies, Saint-Ouen (FR)

(72) Inventor: JUHA PETAJAJARVI, OULU (FI)

(21) Appl. No.: 14/678,036

(22) Filed: Apr. 3, 2015

Related U.S. Application Data
(60) Provisional application No. 62/115,494, filed on Feb. 12, 2015.

(51) Int. Cl. H01Q 17/00; H01Q 1/32; G01S 7/02; B61L 15/00

(52) U.S. Cl. CPC H01Q 17/00; B61L 15/0027; H01Q 1/3275; G01S 7/023

(57) ABSTRACT

Systems and methods provide harden wireless intra-vehicular communication against jamming and/or interference. A vehicle comprises a carriage top, an antenna mounted on an outer-vehicle side of the carriage top, and radio frequency absorbing material positioned proximate to the antenna and at least a portion of the carriage top near the antenna.

### BACKGROUND

1. Technical Field

Embodiments of the subject matter disclosed herein relate to providing secure wireless intra-vehicular communications.

2. Discussion of Art

Intra-vehicular communication plays an important role in various public and cargo transportation systems (e.g., cruises, trams, metros, articulated buses, trains, and cargo ships) to ensure safety and stable operation of the vehicle. Intra-vehicular communication systems can be used for signaling and control purposes, provisioning of passenger information services, and management of systems on board or which interact with a vehicle (e.g., announcement systems, video surveillance, intercom, heating, ventilation, air-conditioning, broadband services and data-driven control systems).

Conventional wired intra-vehicular communication systems utilize wired lines laid along the vehicle body with interconnecting couplers at junction points or interfaces. In comparison with wireless transceivers, physical wires are cumbersome to install, maintain, troubleshoot, and replace. For example, couplers between carriages in articulated buses/trains/metros/trams are frequent points of failure, since the constant motion of the carriages causes the contacts of the couplers to wear out.

Furthermore, wired systems have fixed bandwidths, limited data rates, and a limited number of ports. Wired systems cannot be expanded without reinstalling wires across the vehicle. Thus, a wired communication system is expensive and not efficient to upgrade to accommodate future demands. Especially, wired systems are not scalable and practicable enough to provide individually customized user services (e.g., broadband access, multimedia services) for thousands of passengers.

Accordingly, it is expected that intra-vehicular communication systems will become increasingly reliant on wireless communication technology to support the efficient, reliable transmission and reception of data in and around the vehicle. The use of wireless technologies for intra-vehicular communication is an economical, expandable, reliable, and user-friendly alternative to wired communications. Moreover, it is easy to upgrade wireless systems to support emerging passenger related applications in the future. Hence, wireless communication is a natural fit for intra-vehicular communication.

However, existing architectures are not able to adequately address security challenges in wireless intra-vehicular communication systems. Specifically, open air transmission exposes the control and user traffic to third party attackers. In particular, an interruption of the control data may result in compromising the safety and the smooth operation of the vehicle.

### BRIEF DESCRIPTION

In one embodiment, an intra-vehicular communication system is provided. The system includes, in one embodiment, a vehicle (e.g., rail vehicle) comprising a carriage top, an antenna mounted on an outer-vehicle side of the carriage top, and radio frequency absorbing material positioned proximate to the antenna and at least a portion of the carriage top.

In one embodiment, an intra-vehicular communication system is provided. The system includes a vehicle consist (e.g., rail vehicle consist) that comprises at least a first vehicle (e.g., a first rail vehicle) and a second vehicle (e.g., a second rail vehicle). The first vehicle has a first carriage top, a first antenna mounted on an outer-vehicle side of the first carriage top, and first radio frequency absorbing material positioned proximate to the first antenna and at least a portion of the first carriage top. The second vehicle of the plurality of vehicles has a second carriage top, a second antenna mounted on an outer-vehicle side of the second carriage top, and second radio frequency absorbing material positioned proximate to the second antenna and at least a portion of the second carriage top.

In one embodiment, an intra-vehicular communication method is provided. The method relates to hardening a wireless radio frequency communication system on a first vehicle of a consist of vehicles (e.g., rail vehicle consist) against a source of jamming or interference located within an interior region of any vehicle of the consist of vehicles. The method comprises installing radio frequency absorbing material proximate to an antenna of the wireless radio frequency communication system that is mounted on an outer-vehicle side of a carriage top of the first vehicle. The radio frequency absorbing material is configured to absorb electromagnetic energy over a responsive radio frequency bandwidth of the antenna.

### BRIEF DESCRIPTION OF THE DRAWINGS

Reference is made to the accompanying drawings in which particular embodiments and further benefits of the invention are illustrated as described in more detail in the description below, in which:

FIG. 1 illustrates a rail vehicle consist (e.g., train) having a plurality of rail vehicles;

FIG. 2 illustrates a consist of rail vehicles;

FIG. 3 schematically illustrates a consist of rail vehicles;

FIG. 4 illustrates a system for wireless communication in the presence of a jamming source:

FIG. 5 illustrates a system for wireless communication in the presence of a jamming source with radio frequency absorbing materials between the jamming source and wireless communication components;

FIGS. 6A, 6B, 6C, 6D, 6E, and 6F illustrate test results relating to FIGS. 4 and 5; and

FIG. 7 illustrates a method for hardening a wireless communication system against jamming and interference.

### DETAILED DESCRIPTION

Systems and methods for shielding wireless intra-vehicular communication from jamming are described herein. A system mitigating jamming of intra-vehicular wireless communication includes the use of radio frequency (RF) blocking or absorbing material between likely locations of jamming devices within unsecured areas of the vehicle and transceivers used for intra-vehicular communication.

With reference to the drawings, like reference numerals designate identical or corresponding parts throughout the several views. However, the inclusion of like elements in different views does not mean a given embodiment necessarily includes such elements or that all embodiments of the invention include such elements.

“Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing device” or “computing device” or “processor” as used herein includes, but is not limited to, any programmed or programmable device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. The terms “controller” or “control system” or “control device” are used broadly herein and may be anything from a simple switching device, to one or more processors running computer-executable software instructions, to complex programmable and/or non-programmable logic circuitry. The terms “signal”, “data”, and “information” may be used interchangeably herein and may be in digital or analog form.

The term “functionality” as used herein may refer to the logical actions and supporting display screens of a system implemented in software and/or hardware. The term “electronically” as used herein may refer to performing a task using an electronic device or network, or any equivalent thereof (e.g., a fiber optic device or network, or some other form of digital device or network). The term “nodes” or “node devices” as used herein may refer to legacy equipment devices on a vehicle that are operatively connected to wired infrastructure within a secure zone such as, for example, electrical equipment associated with a rail vehicle.

The term “vehicle” refers to any transportation system of one or more coupled compartments. Specifically, as suggested throughout, vehicles need not be a single compartment, permanently-arranged transportation system (e.g., a sedan with fixed capacity), but can include multiple compartment variable arrangements (e.g., a multi-carriage train or bus which can add or remove individual carriages). A single vehicle herein may include multiple sources of power for mobility, such as a railway train having multiple locomotives.

In this regard, “intra-vehicular communication” refers to any communication within a single compartment, or between compartments of a vehicle. Intra-vehicular communication need not, and does not in aspects herein, occur within a single compartment, module, car, or carriage, et cetera, of a consist or other multi-part vehicle system. (“Consist” refers to plural vehicles mechanically or otherwise linked for coordinated travel along a route.)

As used herein, in regard to the relationship between radio frequency blocking materials and antennas. “proximate” means positioned in such a way as to block at least some radio frequency interference originating from a device below the antenna or another possible position of an interference source. In this regard, proximate can mean located on the same vehicle within a consist, or alternatively on another vehicle of a consist which moves with the vehicle on which the antenna is mounted. In specific instances, proximate may describe elements within a defined distance or angular arrangement, or intervening between two points (e.g., a compartment and an antenna).

Radio frequency absorbing material includes materials through which radio signals and/or other energy cannot pass, or materials which permit only a small fraction of such energy to cross between sides of the materials. In instances, radio frequency absorbing material does not reflect a substantial portion of radio signal at its incident strength, but rather permits it to pass partway through without transmitting a substantial portion of the signal through or in another direction (e.g., absorbs or scatters). An example of radio frequency absorbing material can include ferrite tile absorbing material, which can absorbs radio frequencies in a band between 30 MHz and 1 GHz. In another example, polyurethane foam loaded with carbon absorber material in a spectrum between 100 MHz and 40 GHz. These and other materials can be combined or used independently to absorb or block radio signals in these and other frequency bands.

While coupling of compartments to define the vehicle will generally involve some form of physical connection or contact, it will be appreciated upon review of the disclosures herein that compartments may function together at a distance (e.g., through magnetism or independent means of locomotion). In instances where at least one transportation compartment is utilized at a distance to another compartment, the vehicle may be defined as a plurality of compartments travelling a substantially matching path as a group in unison. This definition may also apply to other arrangements (e.g., mechanically linked cars or carriages). However, intra-vehicular communication need not be conducted between two cars, carriages, or compartments, and may be used to transfer data between components of a single car, bus, truck, et cetera, for control (e.g., braking, light actuation, locking of windows or doors) or convenience (e.g., stream non-control data).

Vehicles need not be confined to any particular type. While examples herein refer to rail vehicles, the disclosures herein are equally applicable to vehicles capable of travelling on improved or unimproved roads, over or through water, airborne, or in space. Further, aspects described herein are not defined to any particular class of vehicle. In a similar spirit, examples herein may be directed toward passenger rail or light rail, but are equally applicable to other classes of rail or transportation.

As discussed, intra-vehicular communication herein is conducted wirelessly. Such wireless communication can be facilitated by, for example, a wireless local area network based on IEEE 802.11 standards. Such wireless communication techniques provide a variety of options in single or multi-band, over different channels or frequencies, all of which are embraced by the scope of this disclosure. Further, other wireless communications techniques such as Bluetooth, infrared, near-field communication, optical wireless communication, or according to various cellular network communication means (e.g., 3G, EDGE, 4G WiMAX, 4G LTE).

While aspects herein generally refer to wireless transceivers, such aspects are not intended to exclude independent transmitters or receivers, or other support modules (e.g., repeaters or relays), which can be incorporated alternatively or in combination with transceivers described herein. More generally. “wireless communication components” can embrace transceivers as well as all other components involved in wireless communication.

As discussed above, vehicles will become increasingly reliant on wireless communication not only for onboard conveniences but also for control of critical components related to vehicle operation and safety. For example, locomotive, environmental control, safety, fuel storage, and other systems are typically distributed across several carriages of a railway train, and end-to-end communication from the lead carriage to the caboose is necessary to the safe and dependable transit of the vehicle. In this regard, interference from the increasing number of unrelated wireless components, and, more dangerously, intentional jamming, have the potential to slow or stop railway progress, or even cause railway disasters.

Therefore, disclosures herein may provide systems and methods for improving the integrity and reliability of wireless intra-vehicular communication at least in part by shielding or hardening wireless intra-vehicular communications against jamming or interference signals within or in close proximity to the vehicle. Wireless intra-vehicular communications can be implemented using directional antennas associated with transceivers to provide improved performance, directivity, and signal strength. In this regard, antennas are oriented such that the main lobes of their transmission direction are oriented in a substantially aligned arrangement during most periods of vehicle travel (e.g., aligned unless antennas mounted on different carriages and train rounding a sharp bend). The antennas can maintain line of sight (e.g., mounted in open air on vehicle roof). In alternative or complementary arrangements, one or more antennas can be mounted without line of sight but such that transmission through the intervening materials remains effective for intra-vehicular communication.

To ensure the directional signals are not interrupted, material that absorbs or blocks radio frequency waves can be placed around transceivers, associated antennas, or other wireless communication components to mitigate or wholly block inadvertent or malicious signals capable of interfering with communication between two or more of the wireless communication components. In particular, material absorbing radio frequency waves can be placed between a wireless communication component and a potential source of jamming. The radio frequency absorbing material can be placed at the top of internal compartments of one or more carriages on an inner side, as one or more layers of intermediate material within a carriage top, or as a top layer of the carriage between the carriage and the wireless communication component. In this fashion, jamming signals from within a carriage will be denied a direct path to the wireless communication component, and jamming can be prevented. Similarly, this will also tend to block nearby ground-based interference sources. While radio frequency absorbing material are shown in the figures in contiguous configurations within or parallel to the roof, ceiling, or top of vehicles, it is understood that other configurations having multiple distinct sections and alternative sizes or geometries are embraced under the scope of this disclosure.

In arrangements where further security is required, partial walls or complete enclosures of radio frequency absorbing material can be arranged around wireless communication components such that the path between wireless communication components is unobstructed but interference from other directions is substantially blocked. Such further configurations can be employed to defeat threat of jamming or interference from airborne, elevated, or sources distant from the path of travel.

In configurations where radio frequency absorbing material is arranged in a configuration parallel to the top of the carriage, there may still be limited spaces where a jammer or other interference source within the carriage can be at least partially effective at interrupting traffic between wireless communication components. However, due to the geometric limitations imposed by the radio frequency absorbing material (e.g., a jammer must now be placed near the ceiling at the center of the carriage), the area of carriage to be searched by personnel is drastically reduced, and risk of discovery greatly increased.

Further anti-jamming or interference mitigation techniques can be employed in conjunction with radio frequency absorbing material and/or directional antennas. For example, anti-jamming modulation techniques, the use of frequency hopping signals, reduction in data rate, or spread spectrum techniques transmitting and receiving over a wide band can all be employed to further harden the wireless intra-vehicular communication systems and methods.

Various radio frequency absorbing or blocking materials can be utilized with aspects herein. Specific materials can be designed or configured to absorb electromagnetic energy of a responsive radio frequency bandwidth of antennas with which they are used in conjunction. For example, a radio frequency absorbing or blocking material can absorb or reflect transmissions with frequencies at or near 2.4 GHz, at or near 5.9 GHz, or between a range exactly or approximately bounded by the frequencies 2.4 GHz and 5.9 GHz. Particular materials used can include, but need not be limited to, dielectric loss type materials, magnetic loss type material, scattering type materials, and interference type materials.

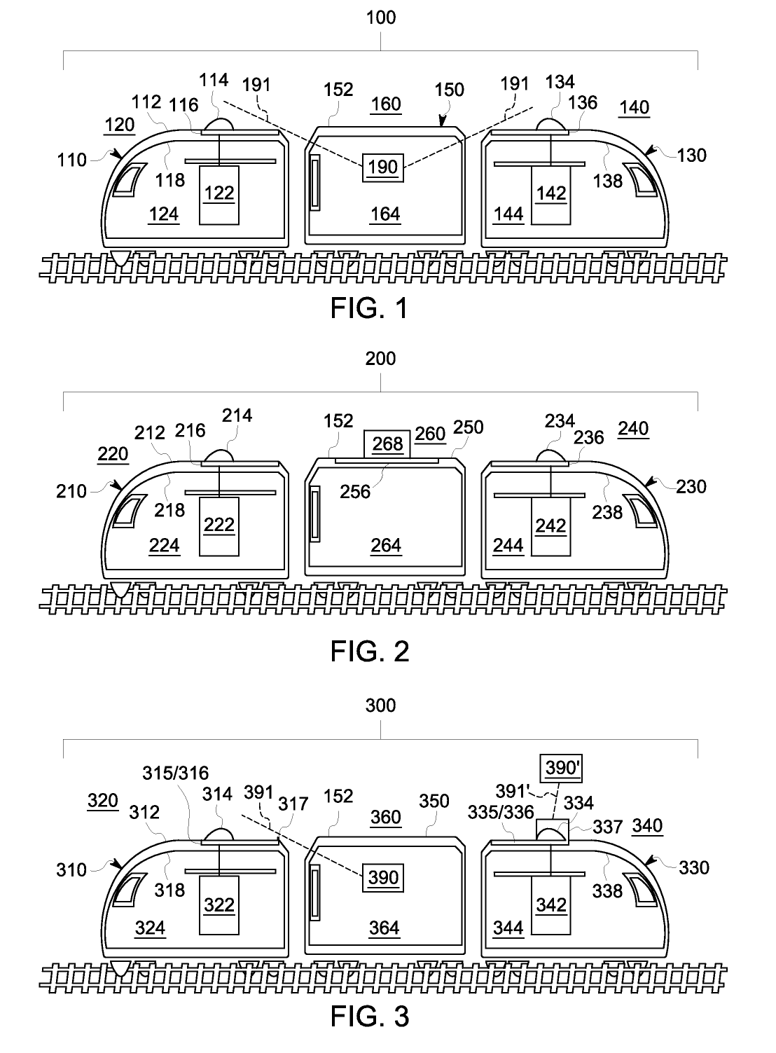

Turning now to the drawings, FIG. 1 illustrates a consist 100 having a plurality of rail vehicles, e.g., carriages. (Rail vehicles are an example of one possible type of vehicle.) As illustrated, the plurality of rail vehicles specifically includes a first rail vehicle 110, a second rail vehicle 130, and a third rail vehicle 150. The first rail vehicle (e.g., carriage) 110 includes a carriage top 112, an outer vehicle side 120, an inner vehicle side 118, and an inner vehicle region 124. The carriage top 112 includes the roof, ceiling, or outer surface above the compartment(s) defined by the inner vehicle region 124. Similarly, the second rail vehicle 130 includes a carriage top 132, an outer vehicle side 140, an inner vehicle side 138, and an inner vehicle region 144, and the third rail vehicle 150 includes a carriage top 152, an outer vehicle side 160, an inner vehicle side 158, and an inner vehicle region 164. One or more of the plurality of rail vehicles of the consist 100 can include a communication system having wireless communication components. As illustrated, the first rail vehicle 110 includes a first communication system 122, and the second rail vehicle 130 includes a second communication system 142.

As illustrated, the first rail vehicle 110 and the second rail vehicle 130 are configured for communication between the first communication system 122 and the second communication system 142 using a first antenna 114 and a second antenna 134. The first antenna 114 and the second antenna 134 can be highly directive antennas, and generally have their main lobes approximating beam solid angle substantially aligned. As illustrated, the first antenna 114 is mounted atop the first rail vehicle 110 and the second antenna 134 is mounted atop the second rail vehicle 130, providing an uninterrupted line of sight between the first antenna 114 and the second antenna 124. By providing an uninterrupted line of sight, standard antennas will suffer only minimal loss in communicating wirelessly, and directional antenna use can be optimized by allowing alignment of the primary directions of transmission.

The first rail vehicle 110 includes a first radio frequency absorbing material 116 positioned proximate to the first antenna 114. The first radio frequency absorbing material 116 can be at least a portion of the first carriage top 112, positioned between the antenna and carriage top 112, within carriage top 112, and/or on an inner-vehicle side 118 of carriage top 112. Similarly, the second rail vehicle 130 includes a second radio frequency absorbing material 136 positioned proximate to second antenna 134. The second radio frequency absorbing material 136 can be at least a portion of the first carriage top 132, positioned between the antenna and carriage top 132, within carriage top 132, and/or on an inner-vehicle side 138 of carriage top 132. While the first radio frequency absorbing material 116 and the second radio frequency absorbing material 136 (and other elements) are shown in a generally symmetrical fashion in FIG. 1 and other illustrations herein, it is appreciated that such symmetrical configurations are not required, and asymmetrical or unequal arrangements are embraced by the scope of this disclosure in configurations alternative to that of, e.g., FIG. 1.

Arranged as such, the first radio frequency absorbing material 116 substantially blocks the first antenna 114 from jamming or interference signals positioned below the antenna 114, and the second radio frequency absorbing material 136 substantially blocks the second antenna 134 from jamming or interference signals positioned below the antenna 114. Because carriage top 112 and carriage top 132 are in an elevated position, and due to the mobile nature of the consist 100, possible jamming or interference signals would be highly effective from within or alongside the consist 100 but for the employment of first radio frequency absorbing material and second radio frequency absorbing material.

By way of example, a jammer 190 is illustrated in the inner vehicle region 164 of the third rail vehicle 150. In some configurations, the third inner vehicle region 164 can be, for example, a freight or passenger compartment. Jammer 190 broadcasts a jamming signal, which can be broadcast in all directions from jammer 190 or directionally. At least a portion of the jamming signal can be represented by one or both of jamming vector(s) 191. As can be appreciated, a “dead space” in which jamming signals are prevented from introducing interference occurs in the space blocked by first radio frequency absorbing material 116 and/or second radio frequency absorbing material 136.

To allow flexibility in discontinuities between the first rail vehicle 110, the second rail vehicle 130, and the third rail vehicle 150, gaps may occur in the radio frequency absorbing material, and it may be possible to orient a jammer or other interference source in a position thwarting the geometries of the first radio frequency absorbing material 116 and/or second radio frequency absorbing material 136. However, because of the limited areas where jamming may be even partially effective, the spaces to be searched to locate the source of jamming (or other interference) is limited to a very small fraction of the consist 100. Further, radio frequency absorbing materials may be employed to cover all overhead areas, including flexible or jointed materials covering or overhanging discontinuities between first rail vehicle 110, second rail vehicle 130, and/or third rail vehicle 150. In this fashion, jamming and interference from below the first antenna 114 and/or the second antenna 134 can be prevented.

Further, positioning of the first antenna 114, second antenna 134, or other components can be rearranged to optimize transmission characteristics or shielding from jamming or interference. For example, to better protect against jamming or interference threats aboard the consist 100, the first antenna 114 may be positioned toward a front or rear end of the first rail vehicle 110, and/or raised or lowered based on the arrangement of the first radio frequency absorbing material 116.

While FIG. 1 and other drawings herein depict a three carriage arrangement for the vehicle consist, it is understood this depiction only provides one example, and that other configurations having more or fewer carriages or component vehicles are embraced under the scope herein. Further, any number of other components (e.g., antennas, radio frequency absorbing materials) can be employed on one or more carriages in varying identical or dissimilar combinations without departing from the scope or spirit herein. For example, one carriage may have two antennas and one radio frequency absorbing material, while another carriage may have one antenna and two radio frequency absorbing materials. Directional and conventional antennas, multiple types of radio frequency absorbing materials, carriages of different design, and other variants can be utilized in single embodiments, in addition to the substantially symmetrical configurations depicted.

FIG. 2 illustrates an embodiment of a consist 200 having a plurality of rail vehicles, e.g., carriages. In the embodiment illustrated, the plurality of rail vehicles specifically includes a first rail vehicle 210, a second rail vehicle 230, and a third rail vehicle 250. The first rail vehicle (e.g., carriage) 210 includes a carriage top 212, an outer vehicle side 220, an inner vehicle side 218, and an inner vehicle region 224. The carriage top 212 includes the roof, ceiling, or outer surface above the compartment(s) defined by the inner vehicle region 224. Similarly, the second rail vehicle 230 includes a carriage top 232, an outer vehicle side 240, an inner vehicle side 238, and an inner vehicle region 244, and the third rail vehicle 250 includes a carriage top 252, an outer vehicle side 260, an inner vehicle side 258, and an inner vehicle region 264. One or more of the plurality of rail vehicles of the consist 200 can include a communication system having wireless communication components. As illustrated, the first rail vehicle 210 includes a first communication system 222, and the second rail vehicle 230 includes a second communication system 242.

The first communication system 222 is configured to communicate, at least in part, using a first antenna 214, which is shielded from interference and jamming by a first radio frequency absorbing material 216. The second communication system 242 is configured to communicate, at least in part, using a second antenna 234, which is shielded from interference and jamming by a second radio frequency absorbing material 236.

To better facilitate communication between the first communication system 222 and the second communication system 242, the third rail vehicle 250 can have a repeater 268 that is configured to relay signals broadcast from the first antenna 214 to the second antenna 234, and/or from the second antenna 234 to the first antenna 214. The repeater 268 can be hardened in a fashion similar to the first antenna 214 and the second antenna 234. This is done by integration of a third radio frequency absorbing material 256 below, within, and/or above third carriage top 252. The third radio frequency absorbing material 256 prevents exploitation of or interference with the repeater 268, ensuring the integrity of the distributed communication system rather than simply insulating endpoint antennas. Such additional hardening is not limited to the repeater 268, and radio frequency absorbing materials or other techniques can be used to protect various other components susceptible to harm or interruption from wireless jamming or interference signals.

FIG. 3 illustrates another embodiment employing alternative geometries of radio frequency absorbing materials. A consist 300 has a plurality of rail vehicles (e.g., carriages). In the embodiment illustrated, the plurality of rail vehicles specifically includes a first rail vehicle 310, a second rail vehicle 330, and a third rail vehicle 350. The first rail vehicle (e.g., carriage) 310 includes a carriage top 312, an outer vehicle side 320, an inner vehicle side 318, and an inner vehicle region 324. The carriage top 312 includes the roof, ceiling, or outer surface above the compartment(s) defined by the inner vehicle region 324. Similarly, the second rail vehicle 330 includes a carriage top 332, an outer vehicle side 340, an inner vehicle side 338, and an inner vehicle region 344, and the third rail vehicle 350 includes a carriage top 352, an outer vehicle side 360, an inner vehicle side 358, and an inner vehicle region 364. One or more of the plurality of rail vehicles of the consist 300 can include a communication system having wireless communication components. As illustrated, the first rail vehicle 310 includes a first communication system 322, and the second rail vehicle 330 includes a second communication system 342.

The first communication system 322 is configured to communicate, at least in part, using a first antenna 314, which is shielded from interference and jamming by a first radio frequency absorbing material 316. The second communication system 342 is configured to communicate, at least in part, using a second antenna 334, which is shielded from interference and jamming by a second radio frequency absorbing material 336.

The first radio frequency absorbing material 316 has a vertical extension 317 creating a vertical barrier at an angle to the planar section 315 of the first radio frequency absorbing material 316 substantially parallel to the carriage top 312. The vertical extension 317 can be incident to the planar section 315 at any angle, but is shown at a substantially perpendicular angle in FIG. 3. The vertical extension 317 can be sized and oriented to avoid blocking or interrupting signals transmitted from or received by the first antenna 314. For example, the vertical extension 317 can be limited to a height below the height of the main lobe of transmission where the first antenna 314 is a directional antenna.

The second radio frequency absorbing material 336 includes an enclosure 337 surrounding the second antenna 334. The enclosure 337 is shown substantially continuous with a planar section 335 of the second radio frequency absorbing material 336 (e.g., second radio frequency absorbing material is substantially monolithic with the enclosure 337 and the planar section 335 built as a single structure), but may be a distinct component in some configurations. As illustrated, one side of the enclosure can be left open to permit clear line of sight or minimize signal disruption sending and/or receiving to, e.g., the first antenna 314 or another wireless communication component.

The benefit of such alternative embodiments can be appreciated in view of a situation where a jammer 390 is within the third rail vehicle 350. The jammer 390 broadcasts a jamming signal, represented at least in part by a jamming vector 391. As shown, by including the vertical extension 317, the standoff between the first antenna 314 and spaces influenced by a jamming signal from jammer 390 is increased without obstructing communication related to the first antenna 314 or dramatically increasing the size of the radio frequency absorbing material 316.

The jammer 390′ illustrates the benefit of using the enclosure 337 to counter an external jamming threat. The jammer 390′ broadcasts a jamming signal represented at least in part by a jamming vector 391′. As shown, the planar section 335 would not protect the second antenna 334 from aerial or other external (e.g., outside the consist 300) jamming threats arranged at an elevated height or sufficient distance. The enclosure 337 defeats such threats by shielding the second antenna 334 in directions on which the second antenna 334 does not transmit or receive. In this fashion, a jammer must be placed within or very close to a transmission path to interrupt signals between the second antenna 334 and the first antenna 314, making jamming extremely difficult for static and even mobile external threats. Further, while the enclosure 337 is shown approximately fitted to the second antenna 334, protection can be further enhanced by using a lengthened enclosure with the second antenna 334 set back under a further length of the enclosure 337 (e.g., portion of the enclosure 337 closer to the first antenna 314 empty, portion of the enclosure 337 farther from the first antenna 314 houses the second antenna 334). In an example, the enclosure 337 can be approximately the length of the second rail vehicle 330, thereby shielding a portion of the space through which the second antenna 334 transmits and receives, and making it nearly geometrically impossible to jam the second antenna 334 without arranging the jammer 390′ directly in the line of sight of the second antenna 334.

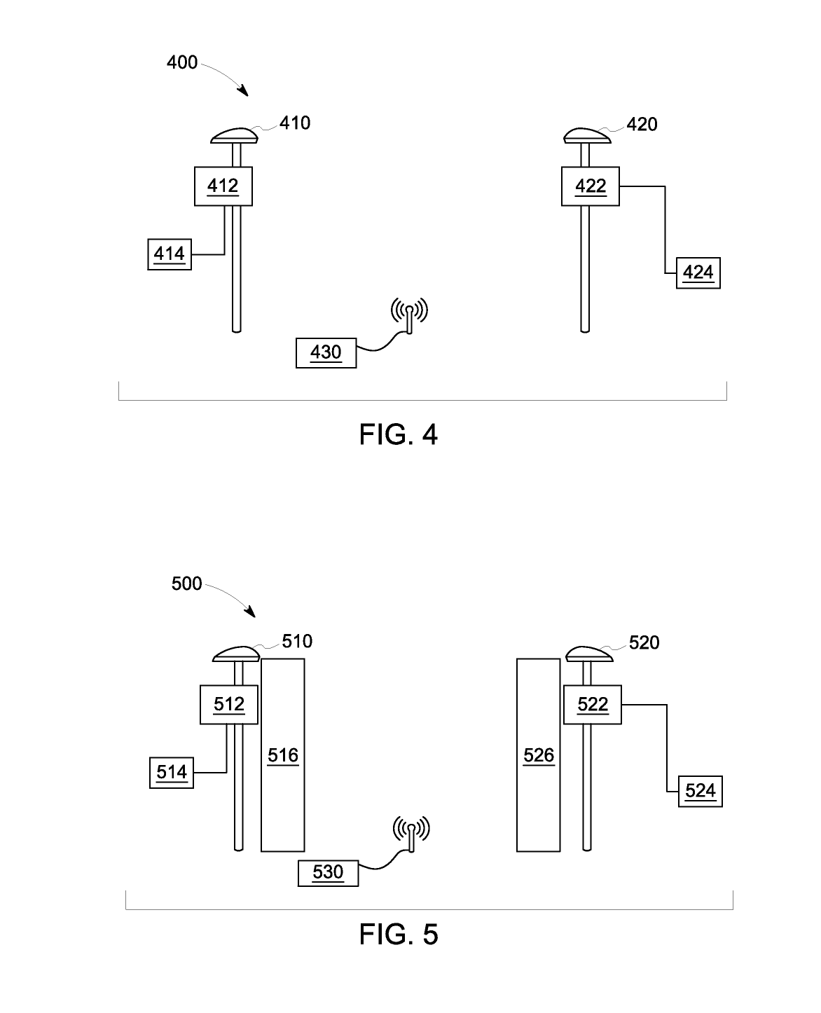

FIGS. 4 and 5 are provided to illustrate the benefit of using radio frequency absorbing materials in conjunction with antennas to combat jamming and interference. FIG. 4 illustrates a system 400 in which a first antenna 410 and a second antenna 420 exchange information wirelessly in conjunction with a first wireless communication system 412 and a second wireless communication system 422, respectively. Endpoints 414 and 424 are employed to provide data for transmission and reception, and assess the effects of jamming by a jamming source 430, arranged between the endpoints 414 and 424. FIG. 5 illustrates a system 500 in which a first antenna 510 and a second antenna 520 exchange information wirelessly in conjunction with a first wireless communication system 512 and a second wireless communication system 522, respectively. Endpoints 514 and 524 are employed to provide data for transmission and reception, and assess the effects of jamming by a jamming source 530, arranged between the endpoints 514 and 524. The distinction between FIGS. 4 and 5 is the integration of a first radio frequency absorbing material 516 and a second radio frequency absorbing material 526 blocking the jamming source 530 from the first antenna 510 and the second antenna 520, which is not present in system 400. In contrast, therefore, the jamming source 430 has line of sight to first antenna 410 and second antenna 420.

The spatial arrangement of tests conducted in FIGS. 4 and 5 can be arranged to mimic those existing in vehicles where radio frequency absorbing material is to be integrated. For example, as implemented in some arrangements of intra-vehicular communication on trains or other consists, first antennas 410/510 and second antennas 420/520 can be separated by approximately 4.5 meters, and elevated approximately 2 meters above jammers 430/530 (e.g., mimicking the approximate relative location of a jammer in a passenger or freight compartment). Other configurations placing first antennas 410/510 and second antennas 420/520 at different distances, heights, angles, or intervening media can be utilized to replicate conditions for other vehicles.

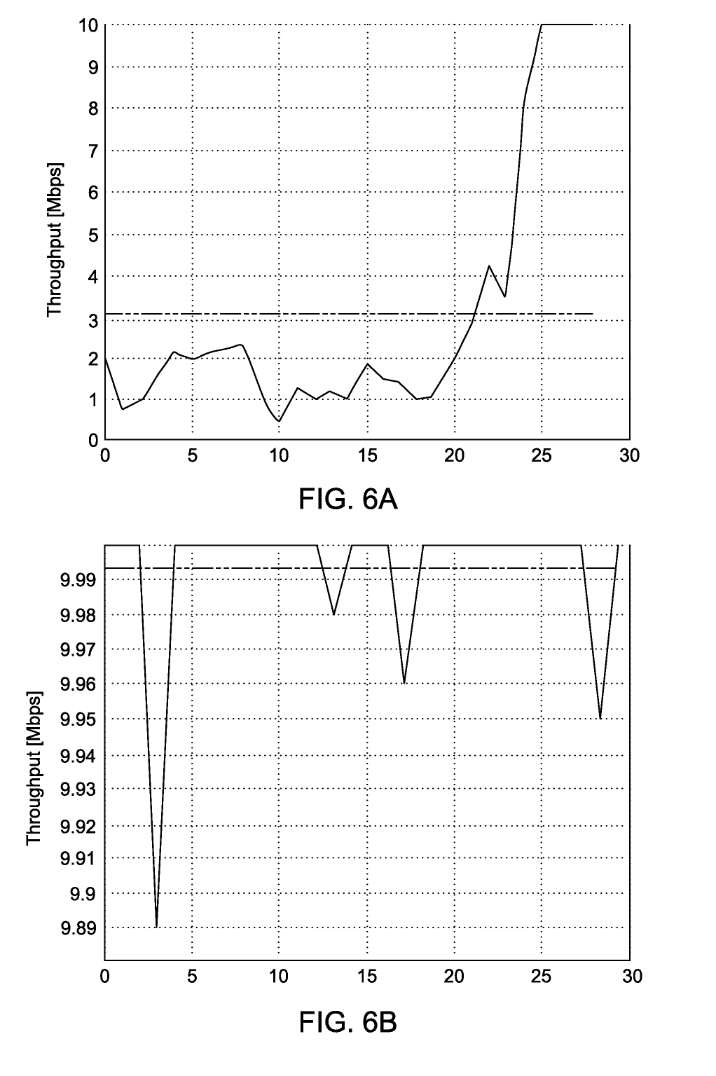

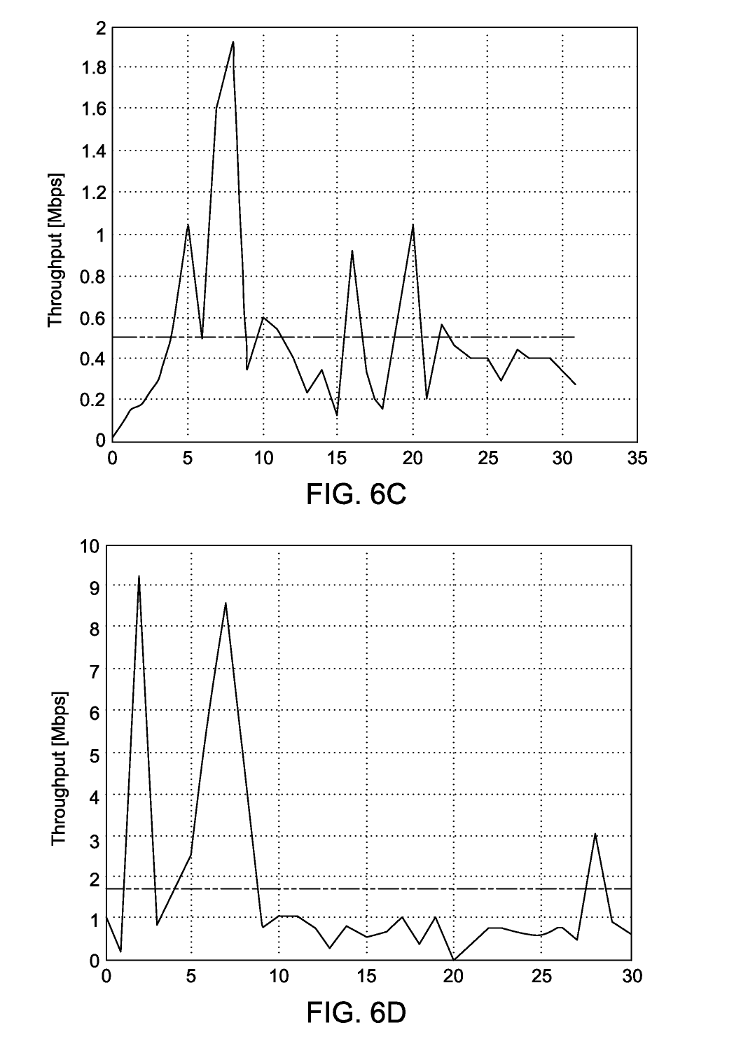

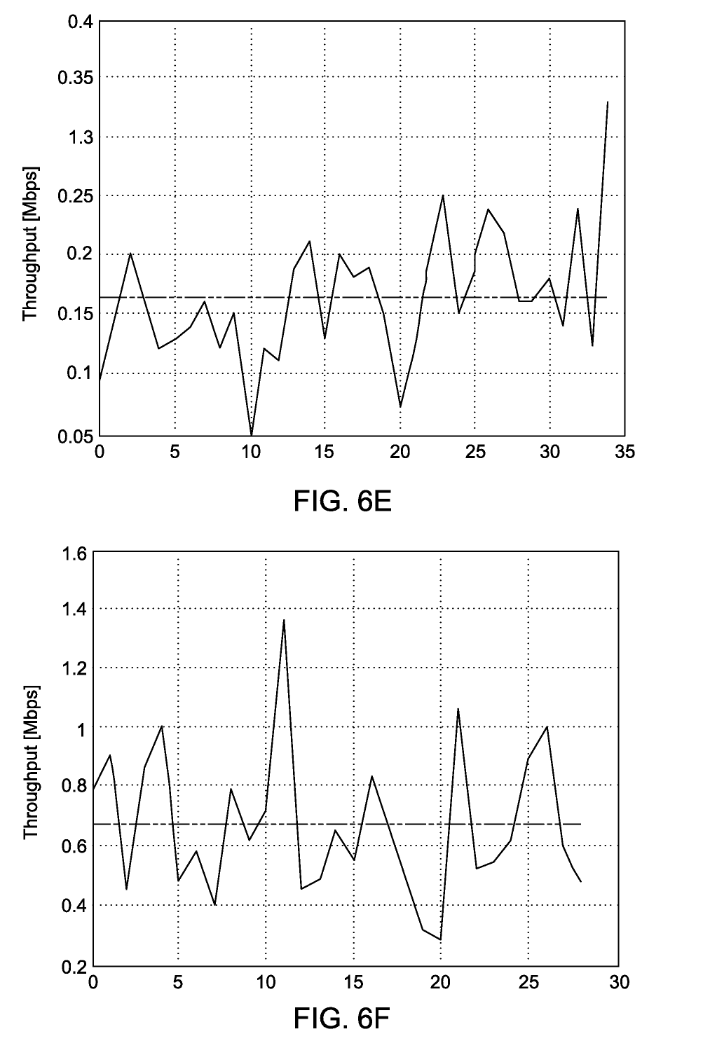

Results of tests conducted in accordance with FIGS. 4 and 5 are illustrated in FIGS. 6A-6F. The test results were produced by arranging first antennas 410/510 and second antennas 420/520 approximately 4.5 meters apart and 2 meters above jamming sources 430/530, with an air transmission media. In the arrangement used to produce the results of FIGS. 6A-6F, first antennas 410/510 and second antennas 420/520 are single input, single output directional antennas broadcasting over dual band 802.11 wireless with a center frequency of 2452 MHz (2.4 GHz). Jammers 430/530 have a jamming signal bandwidth of 20 MHz centered at 2452 MHz.

FIGS. 6A and 6B show transmission throughput in megabytes per second over a period of time with a jamming signal power of 0 dBm for system 400 and system 500, respectively. As can be appreciated based on the dramatic improvement in throughput in FIG. 6B, throughput between the first antenna 510 and the second antenna 520 is nearly triple, on average, the throughput between first antenna 410 and second antenna 420. FIGS. 6C and 6D show the impact of increasing the jamming signal power to 10 dBm, where inclusion of the first radio frequency absorbing material 516 and the second radio frequency absorbing material 526 provides a much higher maximum transmission throughput between the first antenna 510 and the second antenna 520 and approximately triple the average transmission throughput in comparison to the first antenna 410 and the second antenna 420. This improvement is further emphasized in FIGS. 6E and 6F, which show the impact of increasing the jamming signal power to 20 dBm. Inclusion of the first radio frequency absorbing material 516 and the second radio frequency absorbing material 526 provides a maximum transmission throughput and average throughput between the first antenna 510 and the second antenna 520 over four times that between the first antenna 410 and the second antenna 420.

In view of the exemplary devices and elements described herein, methodologies that may be implemented in accordance with the disclosed subject matter will be better appreciated with reference to the flow charts. While for purposes of simplicity of explanation, the methodologies are shown and described as a series of block steps, the claimed subject matter is not limited by the order of the block steps, as some block steps may occur in different orders and/or concurrently with other block steps from what is depicted and described herein. Moreover, not all illustrated block steps may be required to implement the methods described herein, and aspects described as alternative or complementary steps, or as functionality of systems or apparatuses herein, may comprise a portion of methods even if not so illustrated.

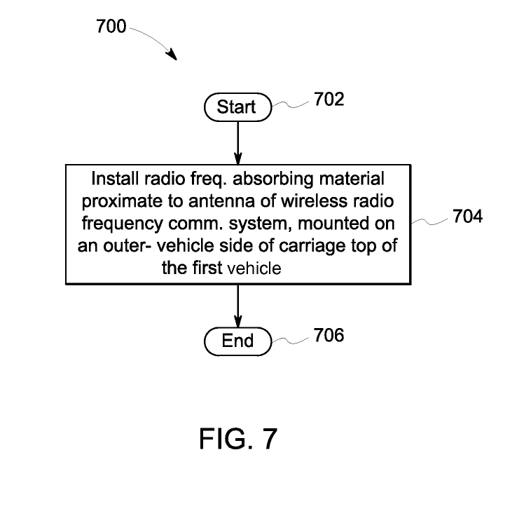

FIG. 7 illustrates a method 700 of hardening a wireless radio frequency communication system, on a first vehicle (e.g., first rail vehicle) of a consist of vehicles (e.g., consist of rail vehicles), against a source of jamming or interference located within an interior region of any vehicle (e.g., any rail vehicle) of the consist of vehicles. Method 700 begins at 702 and proceeds to 704, which comprises installing radio frequency absorbing material proximate to an antenna of the wireless radio frequency communication system mounted on an outer-vehicle side of a carriage top of the first vehicle. In some configurations, the radio frequency absorbing material is configured to absorb electromagnetic energy over a responsive radio frequency bandwidth of the antenna. After installation is complete, method 700 proceeds to end at 706. The method may further include supplemental steps of: providing the radio frequency absorbing material; positioning the radio frequency absorbing material at the location proximate to the antenna; after installation, testing the radio frequency absorbing material as installed, in terms of its effectiveness in absorbing electromagnetic energy over the responsive radio frequency bandwidth of the antenna; and/or based on the testing, re-positioning the radio frequency absorbing material, adding additional radio frequency absorbing material to increase the size of an area covered by the radio frequency absorbing material, and/or adding additional radio frequency absorbing material to increase a thickness of the radio frequency absorbing material.

The aforementioned systems, components, architectures, environments, and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein for the sake of brevity, but known by one of ordinary skill in the art.

Discussing specific embodiments, in one embodiment a rail vehicle comprises a carriage top, an antenna mounted on an outer-vehicle side of the carriage top, and radio frequency absorbing material positioned proximate to the antenna and at least a portion of the carriage top (e.g., near the antenna). In an optional embodiment, the radio frequency absorbing material is positioned between the antenna and the carriage top. Another option provides the radio frequency absorbing material positioned within the carriage top. Still another option provides the radio frequency absorbing material positioned on an inner-vehicle side of the carriage top. The radio frequency absorbing material can be configured to absorb electromagnetic energy over a responsive radio frequency bandwidth of the antenna, and may be configured to operate at or around one or more of the frequencies of 2.4 GHz and 5.9 GHz. The radio frequency absorbing material can comprise one or more of a dielectric loss material, a magnetic loss material, a scattering material, and an interference material.

In another embodiment, a consist having a plurality of rail vehicles is provided. The consist comprises at least a first rail vehicle and a second rail vehicle of the plurality of rail vehicles. The first rail vehicle has a first carriage top, a first antenna mounted on an outer-vehicle side of the first carriage top, and first radio frequency absorbing material positioned proximate to the first antenna and at least a portion of the first carriage top (e.g., near the first antenna). The second rail vehicle of the plurality of rail vehicles has a second carriage top, a second antenna mounted on an outer-vehicle side of the second carriage top, and second radio frequency absorbing material positioned proximate to the second antenna and at least a portion of the second carriage top near the second antenna. The consist can further include a first communication system located within an interior region of the first rail vehicle and operably connected to the first antenna, and a second communication system located within an interior region of the second rail vehicle operably connected to the second antenna. In such arrangements, the first communication system and the second communication system can be configured to wirelessly communicate with each other by direct line-of-sight between the first antenna and the second antenna. Further configurations can include a third rail vehicle of the plurality of rail vehicles having a third carriage top, a repeater apparatus mounted on an outer-vehicle side of the third carriage top, and a third radio frequency absorbing material positioned proximate to the repeater apparatus and at least a portion of the third carriage top near the repeater apparatus. In such configurations, a first communication system located within an interior region of the first rail vehicle and operably connected to the first antenna can be configured to wirelessly communicate through the repeater apparatus with a second communication system located within an interior region of the second rail vehicle and operably connected to the second antenna. In a further embodiment, the first radio frequency absorbing material is configured to block a direct line-of-sight between the first antenna and a radio frequency jamming device located anywhere within an interior region of any of the plurality of rail vehicles, and/or the second radio frequency absorbing material is configured to block a direct line-of-sight between the second antenna and a radio frequency jamming device located anywhere within an interior region of any of the plurality of rail vehicles. In addition, in arrangements having a third rail vehicle having a repeater, the third radio frequency absorbing material is configured in at least one embodiment to block a direct line-of-sight between the repeater apparatus and a radio frequency jamming device located anywhere within an interior region of any of the plurality of rail vehicles.

Another embodiment relates to a method of hardening a wireless radio frequency communication system on a first rail vehicle of a consist of rail vehicles against a source of jamming or interference located within an interior region of any rail vehicle of the consist of rail vehicles. The method comprises installing radio frequency absorbing material proximate to an antenna of the wireless radio frequency communication system mounted on an outer-vehicle side of a carriage top of the first rail vehicle. The radio frequency absorbing material can be configured to absorb electromagnetic energy over a responsive radio frequency bandwidth of the antenna. In further arrangements, the radio frequency absorbing material is installed in one or more positions including between the antenna and the carriage top, within the carriage top, or on an inner-vehicle side of the carriage top. The radio frequency absorbing material can be configured to block a direct line-of-sight between the antenna and a source of jamming or interference located anywhere within an interior region of any rail vehicle of the consist of rail vehicles. The radio frequency absorbing material can include one or more of a dielectric loss material, a magnetic loss material, a scattering material, and an interference material.

In addition to the communication systems described, others can be integrated aboard various vehicles and used for other forms of communication within or beyond a vehicle. For example, an internet connection can be enabled with access points aboard a train or other consist. However, the access points would not be shielded from jamming, as this would interfere with passenger ability to connect to the access points. In this manner, there can be more than one wireless communication means used, with wireless communications dedicated to vehicle function hardened against jamming or interference and less critical systems arranged outside hardened areas to facilitate connection stability and bandwidth within compartments of the vehicle.

A vehicle (e.g., rail vehicle or otherwise) can comprise a carriage top, an antenna mounted on an outer-vehicle side of the carriage top, and radio frequency absorbing material positioned proximate to the antenna and configured to block at least some radio frequency interference originating from a device below the antenna (e.g., inside an interior of the vehicle). For example, the radio frequency absorbing material may be configured to absorb electromagnetic energy over a responsive radio frequency bandwidth of the antenna. According to an aspect, the radio frequency absorbing material is different from some or all of the materials of the carriage top, e.g., the carriage top may be made of metal sheeting, and the radio frequency absorbing material is a different material than the metal sheeting. According to another aspect, additionally or alternatively, the radio frequency absorbing material is not a structural component of the vehicle, that is, it is not required for maintaining structural stability of the vehicle.

Although a “carriage” is indicated in certain examples herein as being a type of rail vehicle, this term is not limited to rail vehicles unless otherwise explicitly specified as such. Thus, unless otherwise specified, uses such as “carriage top” refer to vehicle rooftops generally.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed is:

1. A vehicle, comprising:
a carriage top;
an antenna mounted on an outer-vehicle side of the carriage top; and
radio frequency absorbing material positioned proximate to the antenna and at least a portion of the carriage top.

2. The vehicle of claim 1, wherein the radio frequency absorbing material is positioned between the antenna and the carriage top.

3. The vehicle of claim 1, wherein the radio frequency absorbing material is positioned within the carriage top.

4. The vehicle of claim 1, wherein the radio frequency absorbing material is positioned on an inner-vehicle side of the carriage top.

5. The vehicle of claim 1, wherein the radio frequency absorbing material is configured to absorb electromagnetic energy over a responsive radio frequency bandwidth of the antenna.

6. The vehicle of claim 1, wherein the antenna is configured to operate at or around one or more of the frequencies of 2.4 GHz or 5.9 GHz.

7. The vehicle of claim 1, wherein the radio frequency absorbing material comprises one or more of a dielectric loss material, a magnetic loss material, a scattering material, or an interference material.

8. A vehicle consist comprising:
a first vehicle having a first carriage top, a first antenna mounted on an outer-vehicle side of the first carriage top, and first radio frequency absorbing material positioned proximate to the first antenna and at least a portion of the first carriage top; and
a second vehicle having a second carriage top, a second antenna mounted on an outer-vehicle side of the second carriage top, and second radio frequency absorbing material positioned proximate to the second antenna and at least a portion of the second carriage top.

9. The vehicle consist of claim 8, further comprising:
a first communication system, located within an interior region of the first vehicle, operably connected to the first antenna; and
a second communication system, located within an interior region of the second vehicle, operably connected to the second antenna,
wherein the first communication system and the second communication system are configured to wirelessly communicate with each other by direct line-of-sight between the first antenna and the second antenna.

10. The vehicle consist of claim 8, further comprising a third vehicle having a third carriage top, a repeater apparatus mounted on an outer-vehicle side of the third carriage top, and a third radio frequency absorbing material positioned proximate to the repeater apparatus and at least a portion of the third carriage top.

11. The vehicle consist of claim 10, further comprising:
a first communication system, located within an interior region of the first vehicle, operably connected to the first antenna; and
a second communication system, located within an interior region of the second vehicle, operably connected to the second antenna,
wherein the first communication system and the second communication system are configured to wirelessly communicate with each other through the repeater apparatus.

12. The vehicle consist of claim 10, wherein the third radio frequency absorbing material is configured to block a direct line-of-sight between the repeater apparatus and a radio frequency jamming device located anywhere within an interior region of any of the first, second, and third vehicles.

13. The vehicle consist of claim 8, wherein the first radio frequency absorbing material is configured to block a direct line-of-sight between the first antenna and a radio frequency jamming device located anywhere within an interior region of any of the first and second vehicles.

14. The vehicle consist of claim 13, wherein the second radio frequency absorbing material is configured to block a direct line-of-sight between the second antenna and the radio frequency jamming device located anywhere within an interior region of any of the first and second vehicles.

15. A method of hardening a wireless radio frequency communication system, on a first vehicle of a consist of vehicles, against a source of jamming or interference located within an interior region of any vehicle of the consist of vehicles, the method comprising:
installing radio frequency absorbing material proximate to an antenna of the wireless radio frequency communication system that is mounted on an outer-vehicle side of a carriage top of the first vehicle,
wherein the radio frequency absorbing material is configured to absorb electromagnetic energy over a responsive radio frequency bandwidth of the antenna.

16. The method of claim 15, wherein the radio frequency absorbing material is installed between the antenna and the carriage top.

17. The method of claim 15, wherein the radio frequency absorbing material is installed within the carriage top.

18. The method of claim 15, wherein the radio frequency absorbing material is installed on an inner-vehicle side of the carriage top.

19. The method of claim 15, wherein the radio frequency absorbing material is configured to block a direct line-of-sight between the antenna and the source of jamming or interference located anywhere within the interior region of any vehicle of the consist of vehicles.

20. The method of claim 15, wherein the radio frequency absorbing material comprises one or more of a dielectric loss material, a magnetic loss material, a scattering material, or an interference material.
